(19) United States
(12) Patent Application Publication
(10) Pub. No.: US 2015/0120378 A1
(43) Pub. Date: Apr. 30, 2015

(54) METHODS AND SYSTEMS FOR PRODUCT CONSUMPTION DETERMINATION

(71) Applicant: GRAPHTRACK CORPORATION, Baltimore, MD (US)

(72) Inventor: Nilou Sarah Arden, Baltimore, MD (US)

(73) Assignee: Graphtrack Corporation, Baltimore, MD (US)

(21) Appl. No.: 14/127,232

(22) PCT Filed: May 29, 2013
(86) PCT No.: PCT/US13/42973

§ 371 Date: Dec. 30, 2013

Related U.S. Application Data
(60) Provisional application No. 61/652,937, filed on May 30, 2012.
(60) Provisional application No. 61/672,730, filed on Jul. 17, 2012.
(60) Provisional application No. 61/684,923, filed on Aug. 20, 2012.

(51) Int. Cl. G06Q 30/02

(52) U.S. Cl. CPC G06Q 30/02
USPC 705/7.29

(57) ABSTRACT

Methods and systems for acquiring, processing and tracking product consumption data acquired from a point of sale and standardizing the consumption data using financial transaction data are provided. The method includes acquiring member information, product information and purchase ticket information for a given purchase by a given member where the member includes an individual, a household, a group, a third party, or combinations thereof. Associating product content dimensions with products for at least two purchases, where the product content dimensions include quantitative or qualitative values of any of nutrients, calories, ingredients, chemicals, and combinations thereof. Generating a cumulative set of data points for a given product content dimension over a period of time or set of purchases. Fitting the data to trend equations where slopes can be used to determine consumption rates for a given member over a period of time or a set of purchases.

### CROSS-REFERENCE TO RELATED APPLICATIONS

This application is the U.S. National Stage of International Application No. PCT/US2013/042973, which designated the United States and has been published as International Publication No. WO/2013/181177 and which claims the priority of U.S. Provisional Application No. 61/652,937 filed May 30, 2012, U.S. Provisional Application No. 61/672,730 filed Jul. 17, 2012, and of U.S. Provisional Application No. 61/684,923 filed Aug. 20, 2012. The entire disclosures of those applications are incorporated herein by reference.

### FIELD OF THE INVENTION

The present invention is directed to methods and systems for capturing, transmitting and processing consumer purchase data. More specifically, the present invention is directed to methods and systems for determining and using purchase-based product content consumption.

### BACKGROUND OF THE INVENTION

Conventional methods for tracking nutrition involve individual manual entry of food consumption information (e.g. text or images) into a logbook, table, or form. The limitations associated with these methods can be broadly sectioned into at least four categories of inefficiency. The first category relates to the need for consistent upkeep of data by a user. To remain accurate and actionable, conventional methods require multiple intra-day manual entry of data and result in the loss of time and energy. A number of software applications are available to analyze and visually display the entered food and nutrition data. These applications quickly become inaccurate as data is not entered and thus becomes missing. This first category additionally relates to the unreliability of food consumption habits across multiple days and the irregularity in which data can be entered by an individual. In particular, variability in consumption times throughout a day, sizes of meals, and cooking methods can reduce an individual's motivation in maintaining an accurate nutrition record. The second category relates to the short term nature of meal-specific tracking. Such tracking even if complete is often abandoned after a short period of time (due to multiple reasons such as frustration, near-term achievement, forgetfulness, or life events), thus providing only a snapshot of short term habits (a micro-view of consumption). This does not capture longer term trends that offer a macro-view of consumption or enable macro-level analyses associated with an individual's food consumption or food purchases which can identify both subtle and significant changes in food consumption behavior over varying time periods. The third category relates to tracking nutrition of an individual versus a household. Conventional methods for tracking nutrition frequently focus only on the individual and do not capture a household's nutrition habits over the long term. Household nutrition remains largely neglected by current nutrition tracking systems even while notable correlations exist of nutrition habits among the members of a given household or among the households of a neighborhood. The fourth category relates to having meaningful actionable feedback or targeted messaging to an individual or household based on development of a longer-term trend with respect to a reference household or composite household trend. There is thus a need for a reliable and accurate nutrition tracking systems that is concerned with longer term food consumption habits of an individual or a household and that provides actionable feedback. In particular, such feedback being optimal when based on consumption rates or on predictive analytics of accurate food consumption data. Furthermore, a system as described can provide the backbone to business methods such that revenue can be generated while providing nutrition history and analysis services to benefit consumers, merchants, third parties or combinations thereof. This invention is primarily concerned with reducing the time, effort and inefficiencies associated with traditional methods of nutrition tracking and with presenting a method of analysis to provide accurate consumption rates based on macro-level retail purchase data, thereby creating a nearly effort-free system of nutrition consumption tracking with meaningful and actionable feedback.

Effective sourcing of nutrition information associated with an individual, group, or household can be achieved by acquiring data from a point of sale upon purchasing food products. Prior art attempts that have explored the point of sale as a source of food purchase information for the purpose of nutrition calculations are limited by barriers to deployment of such a system and a minimal focus on the methods related to processing data and calculating accurate consumption rates associated with food purchases. In particular, few have directed attention to providing actionable real-time or near real-time consumption rate data to individuals or households using statistical analyses and predictive analytics associated with a given purchase or history of purchases. The prior art is further limited by the lack of access to all of a consumer's food purchase transaction data resulting in only a partial view of food purchase history. A partial view of food purchases then requires a method of standardization in order to arrive at real-time, near real-time or regularly updated data that is representative of individual or household nutrition consumption. Such standardization has not been taught in the prior art. A limitation to presenting actionable results and consumption rates from a macro-level nutrition tracking system is access to all or most of the individual or household food purchase information. In particular, a method of identifying what percentage of an individual's or household's food product purchases are from tracking-enabled points of sale or merchants and how this translates to a macro-nutrition tracking system adherence indicator for an individual or household is needed. The present invention provides a solution to this limitation through a macro-level consumption-rate calculation method and a method of using financial transaction data from which overall recorded food purchase information is gathered and from which a fuller view of macro-level nutrition consumption is analyzed and delivered to a member of the system such as an individual, household, group, or other entity.

In addition to the benefits that macro-level nutrition tracking can provide health-conscious individuals or households, programs are emerging to address increasingly high health care costs in the United States that enable employers to track groceries purchased by their employees. These programs operate through corporate Human Resources departments that provide coupons to their members for savings on purchases of more nutritious foods such as vegetables and fruits. In return, members of the program reveal more about their grocery purchases to employers who can then track nutrition consumption. This information can keep health care costs down by enticing members to purchase healthier foods and may also be used to identify members who may present a health risk based on their purchases and therefore to lower health insurance costs for the employer.

Other programs that can benefit from macro-level nutrition tracking based on food purchases include marketing initiatives that can utilize the information for targeting products to consumers from a nutrition perspective. Targeted marketing campaigns run by manufacturers, advertisers, loyalty programs, financial institutions, and other entities can better identify consumers for their products or services based on nutrition profiles from food purchases. Furthermore, programs are emerging that enable marketers to identify offline purchase data using customer loyalty information and to target advertisements to appropriate shoppers through online marketing platforms such as Facebook. The frequency of purchases by a given customer can be used in marketing strategies. Companies such as Datalogix analyze customer loyalty programs and purchase data in order to optimize marketing campaigns. However, such programs are limited by offering only a partial view of a shopper's purchase behavior since not all offline purchases are achieved through customer loyalty programs. Additionally, simply providing a frequency of product purchases over a period of time does not address the calculation of intra-product content consumption or define actionable events based on trends in nutrient procurement. In particular, when applied to food purchases, intra-product content consumption rates can be used to assess changes in nutrition consumption behavior over time and events related to such changes. Thus, to optimize such programs a smart consumption rate calculator and tracking system are needed that utilize customer loyalty information with financial transaction history in order to offer a fuller view of a shopper's purchase behavior in a given product category or in a given intra-product content category.

Digital health care initiatives can also directly benefit from an automated nutrition tracking system with macro-level consumption rate calculator that can provide essential information on an individual's diet. Such information can supplement and integrate into other personal health data related to the individual. Digital health platforms are currently being used to assess a fuller picture of an individual's health outcomes based on both genetic and lifestyle factors. Macro-level nutrition consumption rate tracking can provide more data to lifestyle factors used in health and wellness assessments. For example, valuable information can be gathered from tracking nutrition consumption rates, nutrition performance based on a specified diet plans, and such data can supplement medical diagnostic data and other assessments of health outcomes. For example, with a macro-level consumption rate tracker a nutrition performance tracker can determine if the daily recommended value of nutrients has been reached by an individual.

With the increasing desire by customers to track variables related to their health and diets, energy and materials use, waste production and consumption in general, there is an opportunity to provide tracking and analysis platforms for such variables. However, the tracking and analysis platforms must be trustworthy, impervious, and free of additional manual entry. These criteria are critical to achieving adoption, and are among the most essential qualities of the payment processing industry. The present invention provides a solution that satisfies these criteria, and relates to using the payment network to deliver a novel tracking and analysis platform with benefits to both the customer and the payment processing industry.

Individuals that are interested in tracking their diets are likely to collect information such as calorie intake, carbohydrate intake, protein intake, fat intake, and other nutrients. Other individuals may be interested in tracking their pharmaceutical intake, fuel consumption or any other variables related to the consumption of product contents. Since systems requiring manual entry of product information are faced with human factors including inconsistent data entry, adherence to these systems is often reduced. Additionally, information may be entered or tracked incorrectly either accidently or intentionally. A system that does not require consistent manual entry would eliminate many of these issues. Furthermore, the additional use of financial transaction history from payment networks, banks, or directly from the consumer, provides data for expenditures on food-related purchases to support a method of accounting for a subset of purchases from non-tracking enabled merchants or points of sale. Therefore, an optimal solution would work broadly among many merchant establishments, require minimal manual entry and be tolerant of missing data or be able to impute information where it is missing.

In general, the SKU or UPC information can be converted into nutritional statistics and presented in a meaningful way. From a history of such data, at the very least a reasonable lower limit for per-unit-time consumption rates can be determined (e.g., calories per day, fat per day, vitamin C per day). Furthermore, key ratios that do not depend on time can be computed (e.g., fat-to-protein, percent calories from fat). However, such “single-retailer” approaches have not been deployed. Some barriers for the lack of deployment follow. First, the “single-retailer” approach and the approach within the present invention provide a new way of thinking about nutrition computation. Currently many consider manual tracking of individual meals to be their only option for nutrition accounting (the “microscopic” or “fine-grained” approach), and such people do not see that there is at least one broader approach (a “macroscopic” or “coarse grained” approach). Such way of thinking and the lack of precedent create uncertainty about whether a macroscopic approach exists or can deliver benefits. Second, the “single-retailer” approach by itself provides only a lower limit for nutrition consumption rates, because data is not gathered or otherwise accounted from other retailers. This lack of data is thought to be discouraging for users that want to track their nutrition thoroughly but that also prefer to shop at more than one retailer (including restaurants). The appearance of incomplete data again leads to uncertainty about whether a macroscopic approach provided by a single retailer alone would deliver benefits to the user. Third, the “single-retailer” approach is thought to require significant capital expenditure in the form of purchasing host systems for each store, or for purchasing an infrastructure that supports multiple stores of the retailer. The present invention is an approach that overcomes the prior barriers and limitations.

### SUMMARY OF THE INVENTION

Exemplary embodiments of methods and systems in accordance with the present invention provide purchase-based product content analysis and tracking that can be used with financial transaction data to assess product content consumption rates associated with purchases. In one embodiment, for example, the purchase-based product content is the nutritional content of one or more of a plurality of products. For example, products can include but are not limited to retail food products, restaurant menu items, or wholesale food products.

A method for determining product content consumption data from a given purchase is provided. The method includes acquiring member information, product information and purchase ticket information for a given purchase by a given member. A member can include an individual, a household, a group, a third party, or combinations thereof. Member information includes member identification, contact information, payment information, credentials, pass codes, account numbers or combinations thereof. Product information includes product content dimensions, product identifiers, colors, volumes, weights, health indications, packaging information, manufacturers, origin, sources or combinations thereof. Purchase ticket information includes purchase date, purchase time, purchase location, merchant information or combinations thereof. Product content dimensions are then associated with one or more of a plurality of products for at least two purchases by a given member, where the product content dimensions include quantitative or qualitative values of any of nutrients, calories, ingredients, chemicals, and combinations thereof. Nutrients include and are not limited to any of carbohydrates, fats, proteins, minerals, vitamins and combinations thereof. The sum total of one or more of a plurality of product content dimensions associated one or more of plurality of products for a given purchase by a given member is then calculated. Therefore, each purchase is dealt with independently prior to subsequent calculations involving any product content dimension sums from other purchases. Next, cumulative sums are calculated for product content dimensions from a given purchase with the equivalent product content dimensions from at least one past purchase by a given member. A cumulative set of data points is generated for a given product content dimension over a period of time or set of purchases by a given member. The cumulative set of data points is then used to identify consumption data, where consumption data includes but is not limited to rates, trends, ratios or combinations thereof for one or more of a plurality of product content dimensions associated with a given time period or with a set of purchases by a given member. The cumulative set of data points is used to identify one or more of a plurality of trends, where the trend includes but is not limited to equations, lines, curves, or combinations thereof. Slopes for any of equations, lines or curves are then determined and the slopes are then used to determine consumption rates for a given member. In one embodiment, the slopes are used to generate one or more of a plurality of moving averages for the slopes over a period of time and the moving averages can be used to smooth product content consumption rates over a period of time or a set of purchases by a given member.

In one embodiment, any of the member information, product information, purchase ticket information, or combinations thereof, is either acquired from or is received by at least one of a point of sale, a host system, a payment network, a user device, a member, a third party, or combinations thereof. The host system, the payment network or the user device are configured to execute one or more of a plurality of algorithms. Any of the host system, the payment network or the user device can be in communication with a point of sale system. In one embodiment, the product dimensions are retrieved from a database, the database associating product identifiers with product dimensions, where the product identifiers can include but are not limited to barcodes, SKUs, UPCs, names, images, other indicia, identifying features, or combinations thereof.

In one embodiment, the method includes using the consumption data to present textual and graphical representations of historical, current, or predictive consumption data to a given member, member account, user device, third party, output device, or combinations thereof. In another embodiment, the consumption data are nutrition consumption rates based on one or more of a plurality of purchases associated with a given member, the nutrition consumption rates including but not limited to consumption rates of calories, fat, protein, carbohydrates, minerals, vitamins, or combinations thereof over a period of time or set of purchases by a member. In one embodiment, the consumption data is used to identify and communicate suggestions, advertisements, and recommendations or combinations thereof to a member, member account, third party, output device or user device. The user device, output device and member account are in communication with the host system across one or more of a plurality of networks.

Recorded spending is captured by a tracking-enabled merchant. However an approach is needed to account for spending at non-tracking-enabled merchants. One approach to account for spending occurring at these other merchants includes accessing financial transaction data for a given member. Financial transaction data provides information for expenditures on purchases by a given member. In particular, the information can provide a quantitative measure of food-related purchases not captured by tracking-enabled merchants or points of sale. In one embodiment, a member's financial transaction data is acquired. Financial transaction data can include and is not limited to financial amounts associated with each transaction, number of financial transactions, product-type categories, SIC codes, merchant identification, dates of purchases, or combinations thereof. The financial transaction data is used to calculate an adherence metric. In one embodiment, the adherence metric is the ratio of recorded spending at tracking-enabled merchants divided by total spending in one or more of a plurality of product-type categories from a set of purchases, the adherence metric provides an estimated percentage of adherence to tracking-enabled merchants and is used to adjust the consumption data for a given member. For example, product-type categories can include but are not limited to food, beverages, pharmaceuticals, and beauty related products. In one embodiment, the adherence metric is used to update a member account, third party, user device or output device with adherence-adjusted consumption data.

The financial transaction data for a given user can be acquired from any of a payment network, one or more of a plurality of banks, a member, a user device, a third party, or combinations thereof. The adherence metric provides an estimate of consumption for a given product content dimension by dividing the tracked product content consumption by the adherence metric or by a function of the adherence metric. In one embodiment, the method includes using the adherence-adjusted consumption data to present textual and graphical representations of historical, current, or predictive consumption data to a given member, member account, third party, user device, or output device. In another embodiment, the adherence metric is used to present quantitative or qualitative comparisons of consumption data for one or more of a plurality of members, the adherence metric comprising the same or different values, the one or more of a plurality of members comprising the same or different sizes. Furthermore, the adherence-adjusted consumption rate can be used to identify and communicate advertisements, suggestions, recommendations or combinations thereof to a member, third party, member account, user device, or output device.

The method additionally provides for purchase-based gaming feature. In one embodiment, any of consumption rates, adherence metrics, or product content dimensions associated with a given member can be used for gaming, trivia, or targeted communication with the member. In this application a figure of merit is attributed to one or more of a plurality of product information, member information, or purchase information from one or more of a plurality of purchases by a given member. A figure of merit can also be attributed to a consumption rate or an adherence metric associated with a member. The figures of merit and a set of game rules are used to derive or adjust a member score. The member score is then communicated to any of a member account, third party, user device, output device, and combinations thereof. The member score can be used to identify and communicate advertisements, suggestions, recommendations or combinations thereof to any of a member, member account, third party, user device, output device, and combinations thereof.

A system for processing member information, product information and purchase information is provided. The system includes at least one point of sale system configured to transmit member information, product information, and purchase information to a host system. The host system includes at least one server machine, where the server has a communications system for receiving data from and transmitting data to one or more of a plurality of networks, systems or devices, a queuing system and a parsing system configured to organize data, a data storage system, at least one internal processor and internal memory configured to perform computational operations, software configured to execute algorithms. The point of sale system includes but is not limited to any of a retail device, a retail website, a payment terminal, a payment gateway, an entry device, and combinations thereof. The retail device or website provides an interface for merchant checkout. The entry device includes any of a scanner, a keyboard, a near field communication device, an image recognition device and combinations thereof.

The transmissions between the point of sale system and the host system may occur in whole or in part through a payment network, the payment network comprising processes and systems, the processes comprising authentication, authorization and settlement, the systems comprising hardware units, the hardware units configured to execute software. The one or more of a plurality of devices include a user device configured to store, process, transmit or receive data. The point of sale system includes a payment processor configured to acquire, transmit or store member financial transaction history. The host system is in communication with the payment processor, where the payment processor includes one or more of a plurality of front end processors and one or more of a plurality of back end processors. Front end processors are associated with authorization processes and back end processors are associated with settlement processes. The payment processors reside within the payment network. Additionally, the payment network includes connections with financial institutions including credit card issuing banks and merchant banks.

The host system is configured to execute one or more of a plurality of algorithms. In one embodiment, the host system executes algorithms to provide consumption rates over a period of time or set of purchases by a member from tracking-enabled merchants. In another embodiment, the host system provides an adherence metric to determine an estimate of purchases by a member that are not captured by the host system from tracking-enabled merchants. In yet another embodiment, the host system provides both consumption rates from tracking-enabled merchants and an adherence metric to determine an overall estimate or range of consumption for a given product category. For example, a product category can include food-related products. Additionally, the host system includes reference databases and algorithms to identify and communicate suggestions, advertisements, or recommendations to a user device or output device. In one embodiment, the host system includes a nutrition game host or is in communication with a nutrition game host having reference databases and game rules algorithms to identify one or more of a plurality of figures of merit, adjust member scores, identify and communicate suggestions, advertisements, or recommendations based on member scores. The host system is configured to conduct nutritional or product content dimension based games, the games using any of the product information, member information, purchase information, and combinations thereof acquired from a given point of sale transaction.

### BRIEF DESCRIPTION OF THE DRAWINGS

FIG. 1 is an exemplary embodiment of the process flow methodology across a system for capture, processing, storage, and transmission of data in accordance with the present invention;

FIG. 2 is a graph illustrating a set of data points in accordance with the present invention.

FIG. 3 is a graph illustrating trend lines across two sets of data points in accordance with the present invention.

FIG. 4 illustrates exemplary graphical presentations of consumption data in accordance with the present invention.

FIG. 5 is an exemplary embodiment of a system in accordance with the present invention.

FIG. 6 is an exemplary embodiment of a system in accordance with the present invention.

FIG. 7 is an exemplary embodiment of a system in accordance with the present invention.

FIG. 8 is an exemplary embodiment of a system in accordance with the present invention.

FIG. 9 is an exemplary embodiment of a system in accordance with the present invention.

### DETAILED DESCRIPTION

The method of the present invention includes but is not limited to the procurement of product information, member information and purchase ticket information from one or a more of plurality of sources for a given purchase by a member, the summation of one or more of a plurality of product content dimensions associated with one or more of plurality of products from the given purchase, the cumulative summation of the product content dimensions from the given purchase with the equivalent product content dimensions from at least one past purchase, and the identification of functions and their slopes associated with a cumulative set of data points from the purchases. Slopes are used to estimate purchase-based consumption rates for a member where a member includes any of an individual, a group, a household, a third party and combinations thereof. In one embodiment, the method is applied using a tracking-enabled merchant having a point of sale system which is in communication with a host system, where the host system performs the computational operations necessary to calculate purchase-based consumption data for a given member. In another embodiment, member financial transaction history is used to account for any additional purchases from non-tracking-enabled merchants. This additional financial transaction data is used to determine an adherence metric for a given member, where the adherence metric is an estimated measure of adherence to tracking-enabled merchants.

The cumulative summation of a given product content dimension and the subsequent analysis of the set of product content dimension data points over a period of time or a set of purchases provides a consumption rate. Consumption rates are organized and presented as results. In one embodiment, the consumption rates of a number of product content dimensions for a given set of purchases is visualized in graphical format by outputting such results to a member account. The member account can be an online accessible account, a user device application, or other output device allowing a member to view their results.

Such analyses lead to organized information and results which can be used for multiple purposes including but not limited to use by a member for tracking purposes or by a third party to communicate relevant information to the member. Additionally, such results can be useful to a community of members for gaming purposes or for community building purposes. In one embodiment, the results are presented as visualized data or graphs that illustrate consumption data or trend lines based on analyzed consumption data from which consumption rates are derived.

An exemplary process wherein the present invention is applied includes a sales transaction process. A member begins the process by the selection of products at a physical merchant location or a virtual internet-based shop. Product identifiers or SKUs are entered into a point of sale by scanning, touchscreen, keyboard, weight scale or otherwise entering and queuing at a point of sale system where product information is collected. Purchase ticket information is gathered at the point of sale system throughout the checkout process. A member pays for the products by one of at least two payment modes. The first mode includes selecting a payment mode that does not require a payment authorization from a Payment Network or does not require the entry of member information. A Payment Network includes but is not limited to one or more of a plurality of processors and banks such as front-end processors, intermediate processors, back-end processors, merchant bank and card issuing bank. In the case that a member presents cash, a check, a gift card, a coupon, and combinations thereof, upon confirmation of correct payment, the merchant may approve payment. Thus, the purchase ticket is closed out and a reference code or other indicia is printed on the receipt which can be later used to access calculated consumption data or rewards related to the purchase from a web-based application or other application such as desktop software. This completes the sales transaction. Alternatively, a member may select a payment mode that requires payment authorization and presentation of member credentials or identification. For example, the member may present any of credit card, debit card, loyalty card, pre-paid card, smart card, digital signature, and combinations thereof. Member information is captured by the Point of Sale System, which includes member credentials required for successful payment authorization. One or more of a plurality of transmissions may take place to the payment network. A merchant Point of Sale System can be configured to transmit one or more of the product information, member information, purchase ticket information, as a single transmission or as multiple transmissions. Such transmissions may occur under one connection or multiple connections to the Payment Network.

In another exemplary process, once gathered at the Point of Sale System, the member information, product information and purchase ticket information can be queued within the Point of Sale System memory. Once queued at the Point of Sale System, the Point of Sale System processor can combine the information and the data are transmitted using a secure connection (SSL or other) from the Point of Sale System to the Payment Network. If the merchant Point of Sale System is not configured to transmit the entirety of member information, product information, and purchase ticket information to the Payment Network, then the conventional payment authorization can be used to transmit member information and purchase ticket information to the Payment Network and in a separate transmission, the product information may be transmitted to the Host System. Transmission of data to the Payment Network occurs after the Point of Sale System receives, queues, and combines member information, product information, and purchase ticket information.

In another exemplary process the purchase ticket is closed out with an identifier such as a code or other indicia printed on the receipt. The data associated with the identifier include at least the product information from a given purchase but can additionally include purchase information or member information. This data is transmitted to a Host System after a purchase at a tracking-enabled merchant Point of Sale System. Separately, the receipt identifier can be subsequently referenced at a user device in communication with a Host System or with a member account in communication with the Host System in order to access the calculated consumption data for a given purchase or for past purchases. The Host System is in communication with one or more of a plurality of networks. Networks include local area networks (LANs) or wide area networks (WANs). The Host System includes data storage resources or is in communication with data storage units. For example, a data storage device is used to store member and product information. In one embodiment, the Host System containing the stored data performs summation of intra-purchase product content dimensions and then cumulative summation of inter-purchase product content dimensions to determine consumption data and then outputs results or updates past results for the member to access via a user device or via other communication modes. Other communications modes include but are not limited to electronic mail, a member account, a web-based application, a desktop or device application, and combinations thereof. The first summation step includes summing the overall quantity of a given product content dimension from one or more of a plurality of products for a given purchase. This is the intra-purchase summation step. A master database is referenced in this step to retrieve the product content dimension data associated with each product identifier. Therefore, the master database associates product identifiers with product content dimensions. The cumulative summation step is then performed to add product content dimension sums from a set of purchases. This is the inter-purchase summation step. A database containing member-specific product content summations from one or more of a plurality of past purchases is accessed to perform this step. The Host System performs this step to compute the consumption data for a given member over a period of time or set of past purchases. Consumption data include but are not limited to consumption rates, ratios, percentages, quantities, trends or combinations thereof. A set of cumulative data points is generated from the cumulative sums of a given product content dimension and the data points are then used to identify one or more of a plurality of trend lines or equations. One or more of a plurality of slopes are identified using the one or more trends associated with set of data points. In one embodiment, a slope identifies a consumption rate of a given product content dimension over a period of time. In another embodiment, multiple slopes can be identified over a period of time. In one embodiment, a moving average of slopes can be calculated and graphed to smooth the consumption rate over a period of time. Once consumption data are calculated, a member account can be updated with the relevant information. The member account would include a database with member-specific account details. Updates can include consumption related information and other purchased-based information. Therefore, the method facilitates identifying events in which to alert a member based on purchases, product content dimensions, or calculated consumption data. For example, alerts can include updates on member-specified goals such as consumption rates or other nutrition-based goals, updating an electronic shopping list, price reduction alerts, rewards offered by a retailer, recipes, news, similar products, product reviews, rewards, advertisements, suggestions such as suggestions for recipes, recommendations including pairings, or combinations thereof. Such communications to a member can be provided as one or more of a plurality of services and can be achieved by accessing one or more of a plurality of databases to correlate product information or calculated consumption data with relevant events. In one embodiment, data from purchase information or product information can be used as a basis for identifying events to alert a given user. In another embodiment, calculated consumption data are used to identify events to communicate to a member. Providing feedback based on the computed consumption data makes the consumption information useful and actionable by the member or a third party.

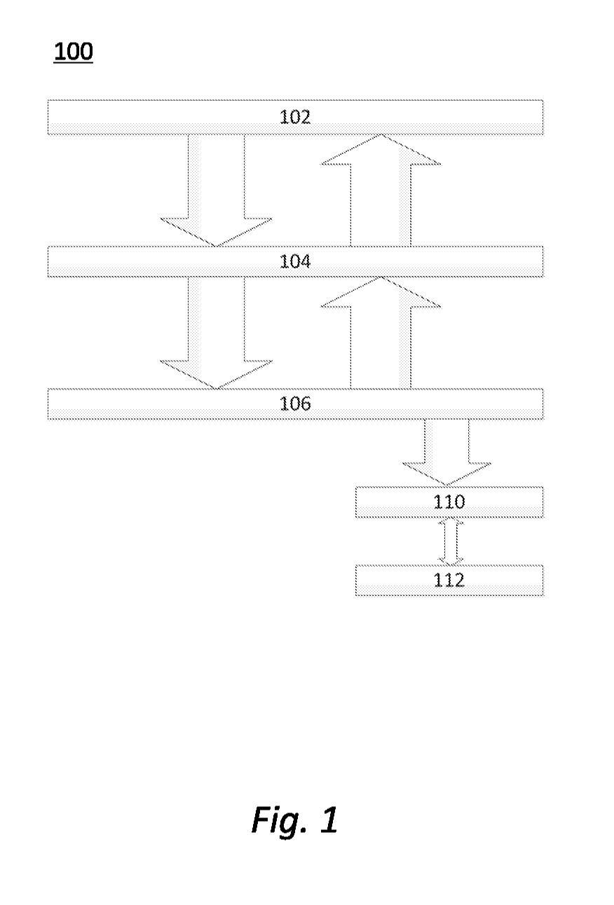

In another exemplary process, the steps of gathering product, member and purchase ticket information can be achieved by other modes. For example, scanning receipts or manual entry can provide the data to a host system where the calculation steps are performed. In the case of scanning receipts, optical character recognition (OCR) software can facilitate entry of data into a database. In one embodiment, the database can be accessed by a host system which can then perform the calculations and update a member account. Referring now to FIG. 1, an exemplary embodiment of a process flow 100 through a system that enables capture, processing, storage and transmission of consumption data in accordance with the present invention is illustrated. The figure shows the communications that occur among a Merchant Retail Device or Website 102, a Payment Terminal or Gateway 104, Payment Network Processors and Banks 106, the Host System 110, and the User Device or Output Device 112. The Retail Device or Website Interface enables checkout of products from a merchant store. The Retail Device or Website Interface captures product, member, and purchase ticket information. The Retail Device or Website Interface is in communication with the Payment Terminal or Payment Gateway 104. The Retail Device or Website Interface 102 transmits any of product information, member information, purchase ticket information, payment request and combinations thereof to the Payment Terminal or Payment Gateway 104. The Payment Terminal or Payment Gateway 104 is configured to transmit any of product information, member information, purchase ticket information, payment authorization request, and combinations thereof to the Payment Network 106. The Payment Network 106 includes Processors such as front-end processors, intermediate processors and back-end processors. The Payment Network 106 processors transmit payment approval or denial to the Retail Device or Website through the Payment Terminal or Payment Gateway 104. In addition, the Payment Network processors transmit member identification, product information, and purchase information to the Host System 110 in whole or in part during at least one of the authorization process, the settlement process, or at another time or processing step. The Host System 110 performs the computations to calculate product content consumption data. The Host System 110 transmits one or more of a plurality of representations of product content consumption data to a User Device or other Output Device 112. Representations conveying product content consumption data include but are not limited to visual, graphical, textual, numerical, and combinations thereof.

A set of collected product content dimension data and the generation of a list of cumulative data points is shown in Table I. In particular, the summation of a product content dimension, in this case, calories are shown over a period of time or set of purchase dates. In one embodiment, the range of time between purchases is indicated by date. In other embodiments, the range of time between purchases may be indicated by other units of time including, but not limited to, days, hours, months, and so on. In one embodiment, the product contents are shown in tabular format. Any product content dimension may be summed in this manner to generate a list of cumulative data points. Other quantifiable product information can be summed which include but are not limited to nutrients, weights, volumes, and combinations thereof

TABLE I

| Range of Time | |
|---|---|
| November 2011- | |
| March 2012 | Product Content Dimension = Calories |

| Date | Value | Cumulative Value |
|---|---|---|
| Mar. 30, 2012 | 7,887 | 238,319 |
| Mar. 24, 2012 | 16,987 | 230,432 |
| Mar. 17, 2012 | 19,110 | 213,446 |
| Mar. 4, 2012 | 18,807 | 194,336 |
| Feb. 29, 2012 | 2,427 | 175,529 |
| Feb. 25, 2012 | 17,897 | 173,102 |
| Feb. 20, 2012 | 3,033 | 155,206 |
| Feb. 12, 2012 | 14,560 | 152,172 |
| Feb. 4, 2012 | 14,953 | 137,612 |
| Jan. 28, 2012 | 19,086 | 122,659 |
| Jan. 15, 2012 | 14,954 | 103,573 |
| Dec. 17, 2011 | 1,820 | 88,619 |
| Dec. 4, 2012 | 3,081 | 86,799 |
| Dec. 2, 2011 | 961 | 83,714 |
| Nov. 29, 2011 | 18,392 | 82,753 |
| Nov. 25, 2011 | 57 | 64,361 |
| Nov. 23, 2011 | 14,275 | 64,304 |
| Nov. 21, 2011 | 19,446 | 50,029 |
| Nov. 20, 2011 | 1,030 | 30,583 |
| Nov. 11, 2011 | 29,553 | 29,553 |

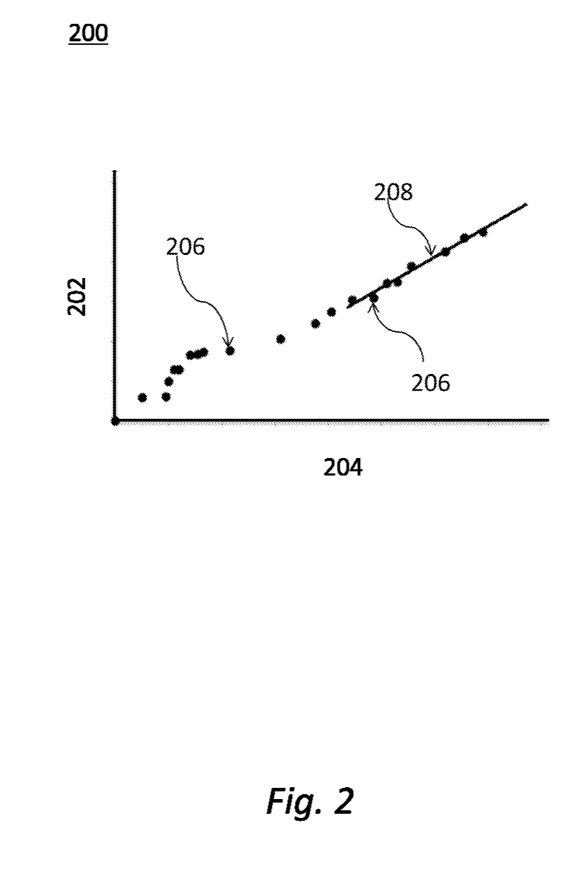

Referring now to FIG. 2, the exemplary graph 200 presents a given product content dimension on the y-axis 202 over a period of time on the x-axis 204. In one embodiment, the cumulative sum total of a given product content dimension can be quantified by weight, calories, or other units. In one embodiment, the graph can be directed to cumulative calories as a function of time. In one embodiment, a point 206 corresponds to one segment of data. In other embodiments, any other product content dimension may be analyzed and graphed or otherwise presented in a similar manner. For example, carbohydrates, fats, proteins, minerals, vitamins, cost, medicines, beverages, fuels, chemicals, and combinations thereof can be graphed. In one embodiment, the point is plotted on a graph of cumulative product content dimension (e.g. cumulative calories) as a function of days. In another embodiment, a trend line is generated and graphed 208. The trend line is a function of a plurality of points in one embodiment. At least two data points can be used to derive a trend line. A trend line equation can be determined such that the slope of the equation can identify the consumption rate of the given product content dimension. For example, if the trend line equation is y=1892.4x−20373, the slope of the equation has a value of 1892.4 which provides the consumption rate of the product content dimension per unit of time. In yet another embodiment, the trend line depicts the member's averaged product-content dimension consumption such as calories per day or more generally, per unit of time. Some data may not be captured and therefore this missing data will not be plotted. Missing data can be treated in a variety of ways. In one embodiment, the values of missing data can be accounted for using an adherence metric. An adherence metric can be provided by the member or can be computed using financial transaction information to determine adherence to tracking-enabled merchants. In one embodiment, the values of missing data can be estimated for by using at least one of the trend line, at least one point, and combinations thereof to determine the missing data. In another embodiment, one or more of a plurality of trend equations are determined including but not limited to one or more of a plurality of regressions, least squares fits, moving averages, Fourier series, polynomials or combinations thereof. In yet another embodiment, any of the regressions, least squares fits, or moving averages are derived from a portion of the cumulative data points. In one embodiment, an older missing data point is predicted by using a new trend equation, such as a regression or moving average. In another embodiment, one or more of a plurality of missing data points can be entered manually. In one embodiment, the member or a group of members can compare at least one of a data point, a trend line, and a combination thereof, with another member or another group of user members. For example, in another embodiment, one of a plurality of trend equations or consumption rates for a member can be compared to one or more of a plurality of trend equations or consumption rates for another member or the same member at a different point in time. In yet another embodiment, one or more of a plurality of trend equations or consumption rates can correspond to a specified nutrition goal, another member, an anonymous member, and combinations thereof.

In some instances, a member is a group where one individual in the group purchases products for one or more of the plurality of individuals. This is common in households therefore one can make household-to-household comparisons. In another instance, a member is one individual that may purchase a batch of products for a party in which not all the products are consumed by the member. In this embodiment, a graph of a given product content dimension as a function of time would include all products consumed by a plurality of individuals, however the data points would all appear to be attributed to a single member but then can be manually attributed to the party or to individuals. In another embodiment, when the member is a group, products shared by the plurality of individuals may be manually attributed, at least partially, to the individuals within the group. In one embodiment, when the member includes a group of individuals, the system can be configured to associate an identifier with each individual of the group. In yet another embodiment, an individual's preference can be manually selected or entered on a user interface or in an application software that is either included or is in communication with the Host System. For example, if the product is retail food, and if the individual is a vegetarian, the system can be configured to not attribute any food products containing meat to the vegetarian individual, whether the member includes the single individual or includes a group of individuals. In one embodiment, a member having a single individual or a member having a group of individuals can be attributed a product content dimension consumption pattern referred to as a signature. In another embodiment, an individual within a group can be attributed a product content dimension consumption signature. A signature can include but is not limited to a trend equation, a percentage, a ratio, or combinations thereof. An nutrition signature can be used to identify a state and to assess deviations from that state. In one embodiment, the consumption signature may be inferred from statistical analysis of the distribution of product content dimensions in a multi-individual member's product purchase history, or a sample history from the member's history. The signature includes, but is not limited to, dietary habits, nutrition consumption data, ratios, fuel types, chemicals, and combinations thereof. In another embodiment, where the member is a group of individuals and purchases are made for a plurality of individuals, the product content dimension consumption data does not require de-convolution or attribution to each individual. The group can compare product-content dimension consumption data to other groups that are statistically similar or to themselves at a different point in time. For example, a household of four people may compare their consumption data to other households of four people. Individuals within a group have incentive to encourage each other and to modify their own behavior for the advancement of the group with such comparisons. In another embodiment, the analyzed data are used to generate at least one of a table, a graph, a suggestion, and combinations thereof. In another embodiment, a member's trend line can be compared to a second trend line where the second trend line can represent any of a target goal, another member, the same member, a group of members, an anonymous member, and combinations thereof. Analysis of the product content dimension consumption data can occur at, at least one of, the point of sale, the host system, the payment network, the payment gateway, the cloud, the user device, and a combination thereof. In one embodiment, data are used to provide at least one of nutrition reports, health reports, data tracking, prediction, pattern identification, notices, coupons, and combinations thereof.

Table II presents the results of a calculation of the adherence metric, and the application of the adherence metric in determining an estimate of a calorie consumption rate. The table presents data for a set of members (A-E) of identical household size. Row 1 shows the duration of the calculation period, retroactive from the present moment (e.g., the last 30 days as shown). In one embodiment, Row 1 is the time period of a given trend line. Row 2 shows the amount spent during the period at tracking-enabled food-related merchants. Row 3 shows the amount spent during the period at all food-related merchants, both tracking-enabled and non-tracking-enabled. Rows 2 and 3 are obtained from analysis of the consumer's financial transaction history. In one embodiment the financial transaction history is obtained from a card-issuing bank. Row 4 shows the adherence metric, which is calculated by dividing the amount in Row 2 by the amount in Row 3. Row 5 shows the calories purchased from the tracking-enabled retailers. Row 6 presents the calories purchased as a per-day rate over the duration of the calculation. In one embodiment, Row 6 can be derived from the slope of a trend line. Row 7 presents an estimate for the calories purchased based on the adherence metric. This estimate is obtained by dividing Row 5 by Row 4. Row 8 presents the estimate for calories as a per-day rate over the duration of the calculation.

TABLE II

| Row | | Member A | Member B | Member C | Member D | Member E |
|---|---|---|---|---|---|---|
| 1 | Duration [days] | 30 | 30 | 30 | 30 | 30 |
| 2 | Spent, tracking-enabled | $110 | $418 | $205 | $542 | $169 |
| 3 | Spent, all food-related | $780 | $550 | $445 | $722 | $375 |
| 4 | Adherence Metric | 14% | 76% | 46% | 75% | 45% |
| 5 | Calories | 10,480 | 44,275 | 23,840 | 52,745 | 18,290 |
| 6 | Calories/day | 349 | 1,476 | 795 | 1,758 | 610 |
| 7 | Estimated Calories | 74,313 | 58,257 | 51,750 | 70,327 | 40,644 |
| 8 | Estimated Calories/day | 2,477 | 1,942 | 1,725 | 2,344 | 1,355 |

It has not been intuitive to provide customers a comparison of consumption data across members from macro-level tracking since individuals shop at a variety of merchants that may not provide a tracking service, leading to different levels of adherence. Such tracking services are currently not offered. Furthermore, a normalization means for comparing users on a common basis is unavailable. For the same reasons, it is not intuitive to compare a single customer at one period of time to the same customer at a different period of time. However, by using the adherence metric, meaningful comparisons can be made among members of the same or similar adherence level. In one embodiment, the adherence metric is determined over the same or similar period of time or range of dates for which used to populate the values of Row 6. In another embodiment, the adherence metric is determined over the same or similar period of time or range of dates for which the cumulative product content dimension consumption at tracking-enable merchants is accounted for. In yet another embodiment, the adherence metric is determined over the same or similar period of time or range of dates for which the regression analysis is conducted. If the member is a household, comparisons can easily be made among households having the same number of individuals. For example, Table II shows that members B and D are comparable at the same adherence level. Similarly, members C and E are comparable based on similar adherence metrics. Furthermore, even if members do not have comparable or equal adherence metrics, the metric can be used to render members comparable. One or more of a plurality of normalization techniques can be applied to adherence metrics leading to comparability. An exemplary normalization technique includes dividing the adherence metric from a consumption rate resulting in an estimate of 100% adherency to electronic transactions. For example, if the caloric consumption rate for a given member is calculated to be 600 calories per day, and the adherence metric for the member is 56%, normalizing to 100% adherency gives 1071 calories per day. Therefore, two members can be easily compared in this manner. Additionally, functions of one or more of a plurality of adherence metrics can be used to compare member to member consumption data or the consumption data of the same member at different time points.

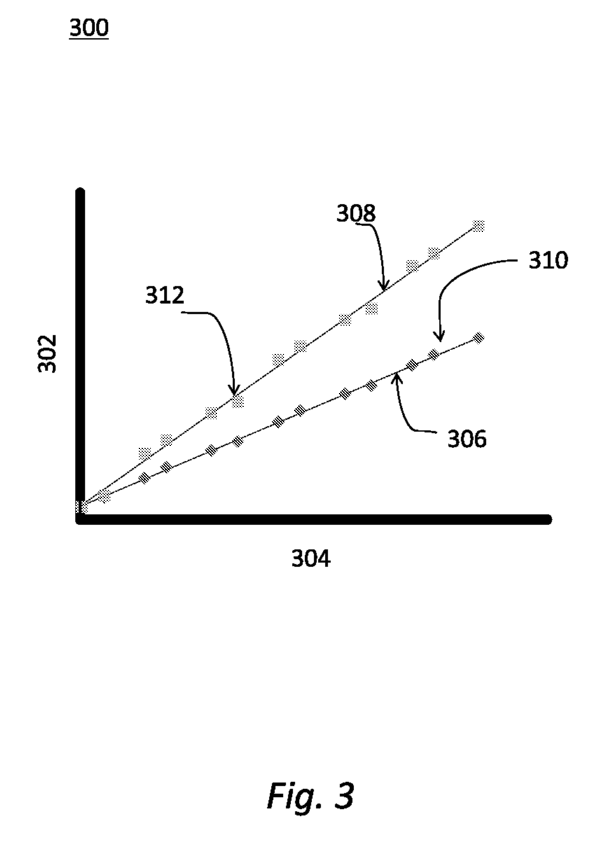

Referring now to FIG. 3, the exemplary graph 300 illustrates two sets of cumulative data points 310, 312 and two trend lines 306, 308. In the exemplary graph, the y axis 302 is the cumulative sum total of a given product content dimension and can be quantified by a selected metric such as weight or calories, for example. The x axis 304 is a period of time or purchase dates. Calculated cumulative consumption data points 310 and adherence-adjusted cumulative consumption data points 312 are shown. The associated equations for each trend line are determined to be y=1520.4x+10073 for trend line 306 and y=2542.4x+10716 for trend line 308. The slopes of the trend lines are identified and can be used to provide information to a member about their purchase-based consumption. For example, setting x to be days and y to be calories, the adherence adjusted cumulative consumption data trend line has a slope of 2542.4 calories/day. In one embodiment, adherence levels fluctuate such that the adherence metric varies throughout the time period for which purchases are accounted for. In another embodiment, adherence levels remain constant such that the percent of adherence to tracking-enabled merchants is steady.

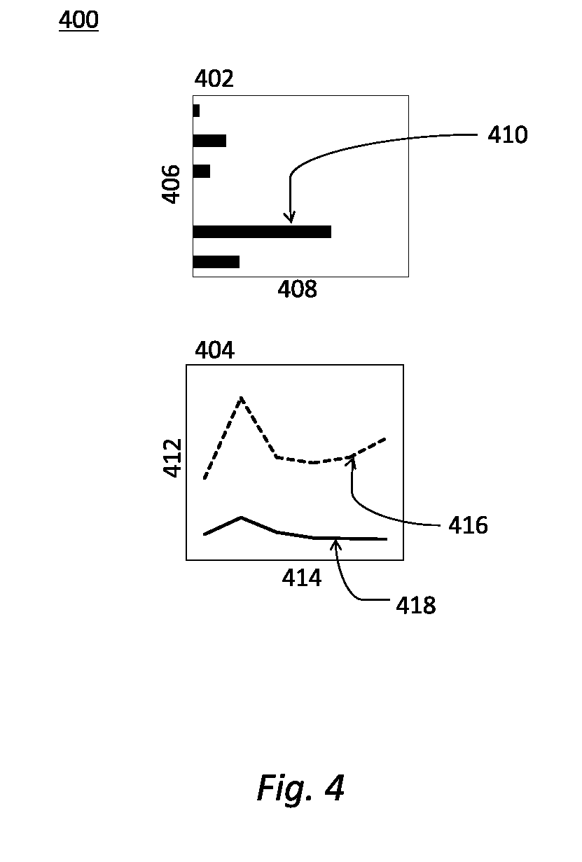

Referring now to FIG. 4, exemplary graphs 402, 404 illustrate a plurality of representations of consumption data. Consumption data can be depicted in various formats including but not limited to textual, visual, colorimetric, and graphical formats. Graphical formats include but are not limited to product content dimension consumption over a period of time, such as calories per unit time, comparative representations of consumption data with daily recommended values, ratios of product content dimensions over a period of time, or combinations thereof. Shown in 402, a set of product content dimensions on the y-axis 406 are analyzed over a period of time to determine average quantity of product content dimension consumption per day. This average quantity of consumption is then compared to its respective 100% daily recommended value. The percent daily recommended value is shown on the x-axis 408. For example, a member can determine if they have achieved the daily recommended value for a given product content dimension 410 (e.g. calcium) over a period of time with this graph. Shown in 404, lines 416, 418 are used to present the trailing average product content dimension consumption rate on the y-axis 412 (e.g. weight, calories, or other measure of quantity) over a period of time on the x-axis 414. For example, line 416 for a first product content dimension (e.g. carbohydrates) and line 418 for a second product content dimension (e.g. fat).

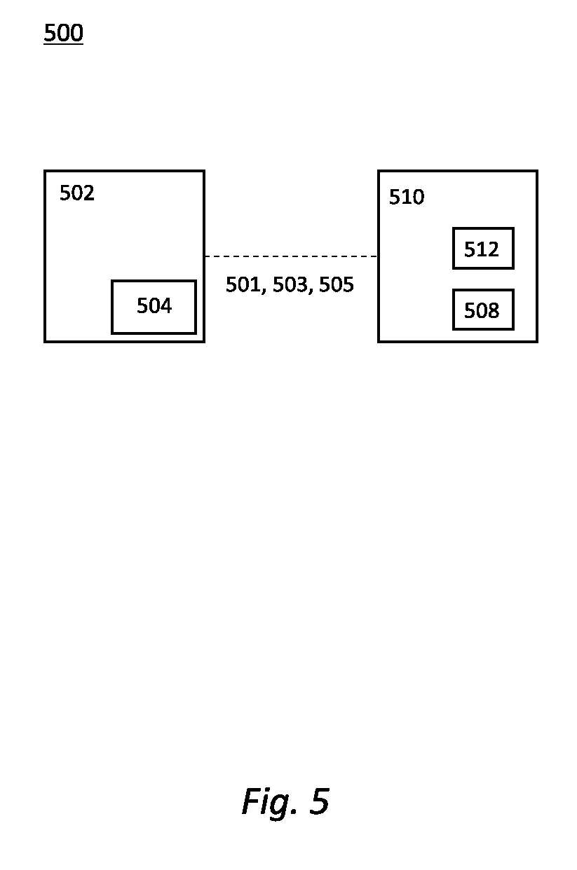

Referring now to FIG. 5, an exemplary block diagram of a system is shown in accordance with the present invention. The system includes a Point of Sale System 502 and a Host System 510. The Host System 510 is configured to receive either the partial or entirety of product information 501, member information 503, purchase ticket information 505 from the Point of Sale System 502. For example, the system receives at least one of the member, product, and purchase ticket information. In one embodiment, the Host System 510 includes at least one Data Storage Device 508. The Data Storage Device 508 provides the Host System 510 with the functionality to store either the partial or entirety of member, product and purchase ticket information. Suitable data storage devices include, but are not limited to, random access memory, flash memory, read-only memory, optical media, solid-state disks, magnetic media, non-volatile or persistent durable drives, compact disks, digital video disks, bluray disks, and secure digital cards. In one embodiment, data are captured at the Point of Sale System 502 through an Interface 504. An interface includes but are not limited to, a barcode scanner, a magnetic stripe reader, a smartcard reader, a QR code reader, a credit card reader, a touchscreen, a scale, a mouse, a keyboard, an image capture device, a near field communication device, a bluetooth enabled device, an olfactory capture device, a payment application, a mobile application, a social media application, and a combination thereof. In another embodiment, the interface may be located in a device including, but not limited to, a phone, a smart phone, an electronic mobile device, a computer, a touchscreen, a tablet, a scanner, and a combination thereof.

The Host System 510 is configured to execute one or more of a plurality of algorithms. In one embodiment, the Host System 510 receives financial transaction histories for a given member and the algorithms utilize the financial transaction history with gathered member information, product information, and purchase ticket information to provide an adherence metric. The adherence metric determines an estimate of purchases not captured by the host system or tracking enabled merchants.

In one embodiment, the Host System 510 is configured to receive and process member information, product information, and purchase ticket information in whole or in part. In another embodiment, the Host System 510 is configured to receive segments of each of member information, product information, and purchase ticket information transmissions simultaneously. These transmissions include, but are not limited to, electromagnetic waves, packet-switched network signals, digital subscriber line signals, fiber optic signals, Bluetooth signals, wireless fidelity signals, microwaves, wireless network transmissions, cellular network signals, and satellite signals. These transmissions can be provided across one or more networks including, but not limited to, local area and wide area networks. In one embodiment, member information and product information may be transmitted from a User Device acting as a Point of Sale 502. In another embodiment, member information and product information may be transmitted from a User Device to a Point of Sale System 502. A User Device includes but is not limited to, a phone, a smart phone, a computer, a touchscreen, a tablet, and combinations thereof. In another embodiment, at least one of member information, product information, purchase ticket information, are transmitted from the Point of Sale System 502, via a Payment Terminal or Payment Gateway 104 or another element of the Point of Sale System 502. In one embodiment, the Point of Sale System 502 includes but is not limited to a Retail Device or Website 102 and a Payment Terminal or Payment Gateway 104.

In one embodiment, the Host System 510 can process and analyze the member information, product information, and purchase ticket information in their entirety. In one embodiment, one or more of a plurality of Processors 512 may remove or redirect the sensitive member financial information from the member information, and subsequently the Processors 512 transmit the remainder of the information to the Data Storage Device 508 or to the payment network. In another embodiment, the Processors 512 temporarily collect member information, product information, and purchase ticket information in whole or in part and then transmit the data to the Data Storage Device 508 or to the Payment Network.

In one embodiment, the Host System 510 includes a game host platform. The game host platform includes algorithms and databases for the purpose of using purchase-specific data for gaming. The game host can include one or more of a plurality of games. Each game is associated with its own set of game rules. For example one set of game rules can be based on product content dimension specific rules. In one embodiment, the game host is configured to access product information for a given purchase by a member to determine one or more of a plurality of figures of merit associated with the product content dimensions from a purchase. A member can select from one or more of a plurality of games. In another embodiment, the member can select the game prior to a purchase. In yet another embodiment, the member can select the game after a purchase. For example, after a purchase of food products, a member can be asked to identify which of a select list of products contains the most protein content by weight. In another example, a member selects a game prior to a purchase such that the purpose of the game is to reach a specified quantity of Vitamin C among the products purchased. A score is then computed by the game host based on one or more figures of merit associated with the select game. In one embodiment, the member score is updated via a member account, user device or output device. In another embodiment, the score is used to issue rewards, communicate suggestions or combinations thereof.

In one embodiment, the host system is configured to transmit product consumption data and relevant events to at least one of, a point of sale system, a payment network, a second system, a processor, a user device, a cloud, a scanner, a collector system, an intermediate device, and a combination thereof. In another embodiment, the host system is configured to receive data from at least one of, the point of sale system, a payment network, a second system, a processor, a user device, a cloud, a scanner, a collector system, an intermediate device, a product, a member, and combinations thereof.

In other embodiments, the one or more of a plurality of Processors 512 can be located external to the Host System 510. In one embodiment, the member information, product information, and purchase ticket information are captured simultaneously at the Point of Sale System 502. In another embodiment, member information and purchase ticket information are transmitted separately from the product information. For example, such cases include but are not limited to when the payment information are processed separately during Payment Authorization. For example, when the product information is processed separately for other operations. In embodiments where member information, product information, and purchase ticket information, or their combinations are transmitted separately from the Point of Sale System 502, a common identifier is associated with each data transmittal so that these data are associated upon arrival at the Host System 510. The common identifier can be a portion of the member information, reference code, or other indicia. Either a single transmission or a combination of transmissions sharing a common identifier may be transmitted across one or more suitable networks.

The Host System 510 is configured to be in communication with any of a User Device, a member account, an application interface, and combinations thereof. In one embodiment, the Host System 510 is configured to transmit alerts to the user device or the member account. Alerts can include but are not limited to updates in consumption data, marketing communications, merchant rewards, offerings, or combinations thereof. An alert can be provided using any user device that is registered or installed with the system or system software including, but not limited to, cellular phones, smart phones, personal digital assistants and computers. Forms for the alert include, but are not limited to, graphical, textual, audible or combinations thereof. In one embodiment, a text message is sent to a smartphone. In another embodiment, social networking sites are used to provide alerts or to receive alert notifications. In yet another embodiment, alerts are communicated using person to person or automated voice messaging services. In one embodiment, the alerts are communicated to a member account. In another embodiment, the alerts are communicated by electronic mail to a given member. A member account can be stored or accessible from at least one of the Host System 504, the Point of Sale System 502, a system within the Payment Network 106, 108, the User Device, an intermediate device, an internet-enabled server, or combinations thereof.

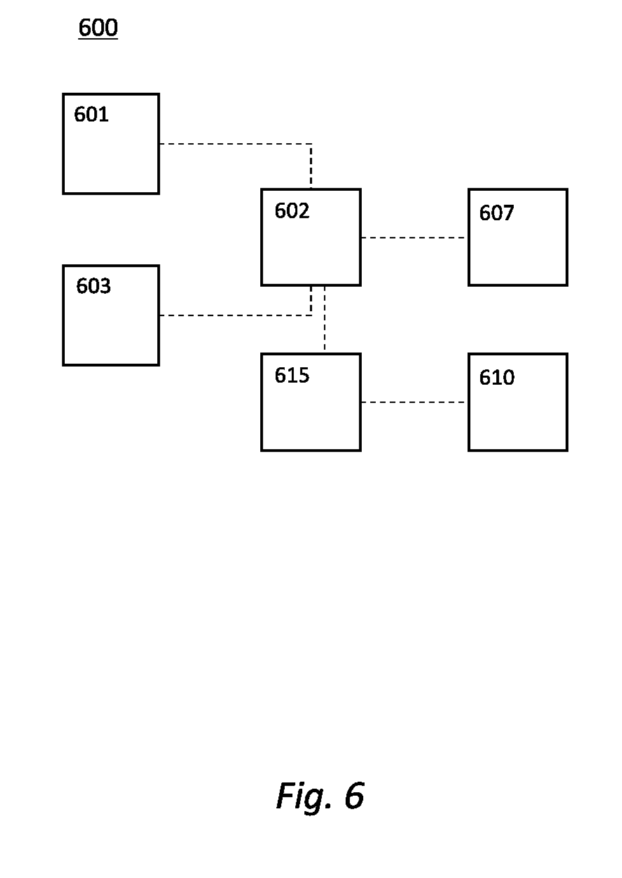

Referring now to FIG. 6, an exemplary embodiment of a system for capture and transmission of data in accordance with the present invention is illustrated. In one embodiment, the product information 601 and member information 603 are entered into the Point of Sale System 602 and purchase ticket information are generated at the Point of Sale System 602. The Point of Sale System 602 is in communication with the Payment Network 607. Such connection enables the conventional payment authorization and settlement process. For example, the Payment Network 607 can be configured to approve and otherwise process sales transactions. Further, the Payment Network 607 has multiple sub-processes and subsystems. In one embodiment, the Point of Sale System 602 is also in communication with an Intermediate Device 615. Such connection enables the transmission of Product information 601 to the Host System 610. In one embodiment, the Intermediate Device 615 is a user device such as a smartphone or a personal computer. In another embodiment, the Host System 610 is included in the Payment Network 607.

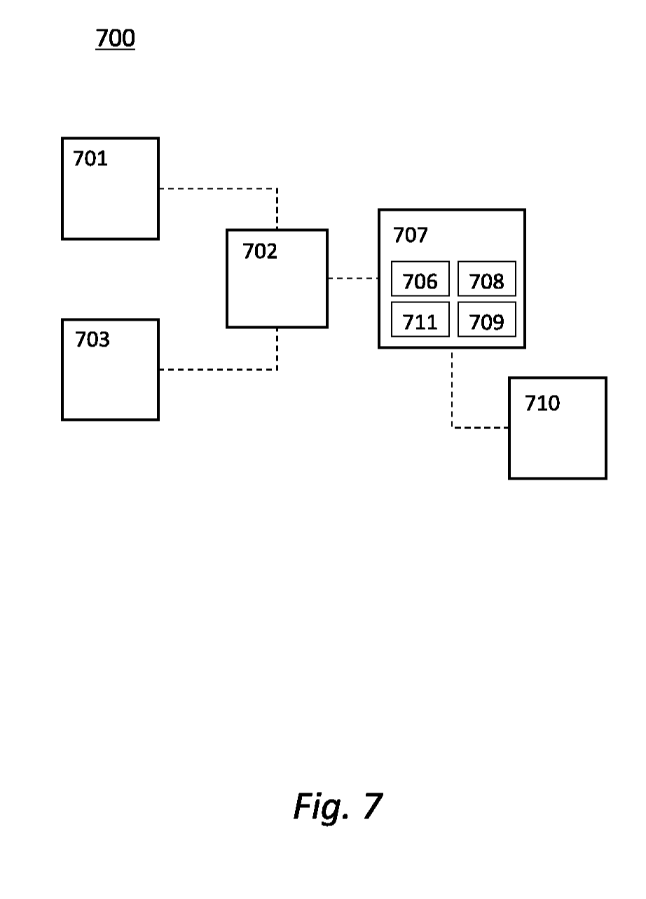

Referring now to FIG. 7, an exemplary embodiment of a system for capture and transmission of data in accordance with the present invention is illustrated. Product information 701 and member information 703 are entered into the Point of Sale System 702. The Purchase ticket information is generated electronically within the Operating System of the Point of Sale System 702. Product information 701 is captured from product packaging, product-specific indicia, a product dispenser, or a user device. Suitable products include, but are not limited to, food products, pharmaceuticals, consumer products, commodities, fuels, and combinations thereof. Member information 703 is captured from a member, member's payment card, a user device, or other form of member credentials. In one embodiment, a Front-End Payment Processor 706 within the Payment Network 707 is in communication with the Point of Sale System 702 and with the Host System 710 enabling the Front-End Payment Processor 706 to be configured to transmit data to the Host System 710 and to the other entities in the Payment Network 707 such as the Back-End Payment Processors 708, Merchant Banks 711 and Card-Issuing Banks 709. In one embodiment, the Front-End Payment Processor 706 is configured to conduct multiple separate processes including authorization. In one embodiment, the Back-End Payment Processor 708 is configured to conduct multiple separate processes including settlement. In other embodiments, the Front-End Payment Processor 706 is in communication with at least one of an Intermediate Device, a User Device, a cloud, a Collector System, or a combination thereof.

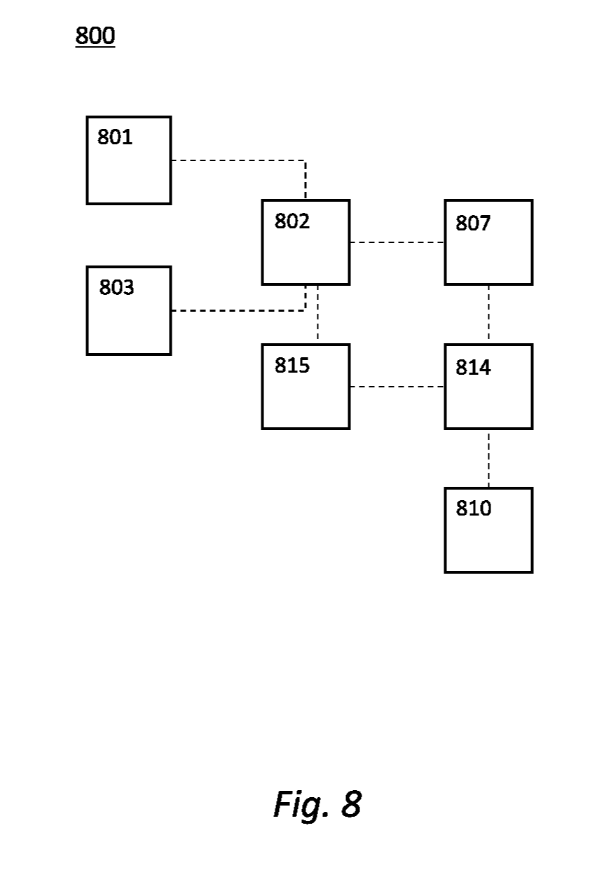

Referring now to FIG. 8, an exemplary embodiment of a system for capture and transmission of data in accordance with the present invention is illustrated. In one embodiment, the product information 801 and member information 803 are entered into the Point of Sale System 802, and the purchase ticket information are generated at the Point of Sale System 802. The Point of Sale System 802 is in communication with the Payment Network 807 and to an Intermediate Device 815. Separately, a Collector System 814 is in communication with both the Payment Network 807 and to the Intermediate Device 815. The Collector System 814 is also in communication with the Host System 810. In some cases, the entirety of product information, member information and purchase information may not be accessible or available from the Point of Sale System 802. Further, in some cases, product information cannot be transmitted to the Payment Network 807. For example, the member information and purchase ticket information are transmitted to the Payment Network 807, while product information is transmitted through an Intermediate Device 815. Both transmissions contain a unique common identifier to enable subsequent matching of data. The data meet again at the Collector System 814, which gathers either the partial or the entirety of member information, product information and purchase ticket information. The Collector System 814 subsequently transmits either the partial or entirety of member, product and purchase ticket information to the Host System 810. In one embodiment, the Collector System 814 is within the Host System 810.

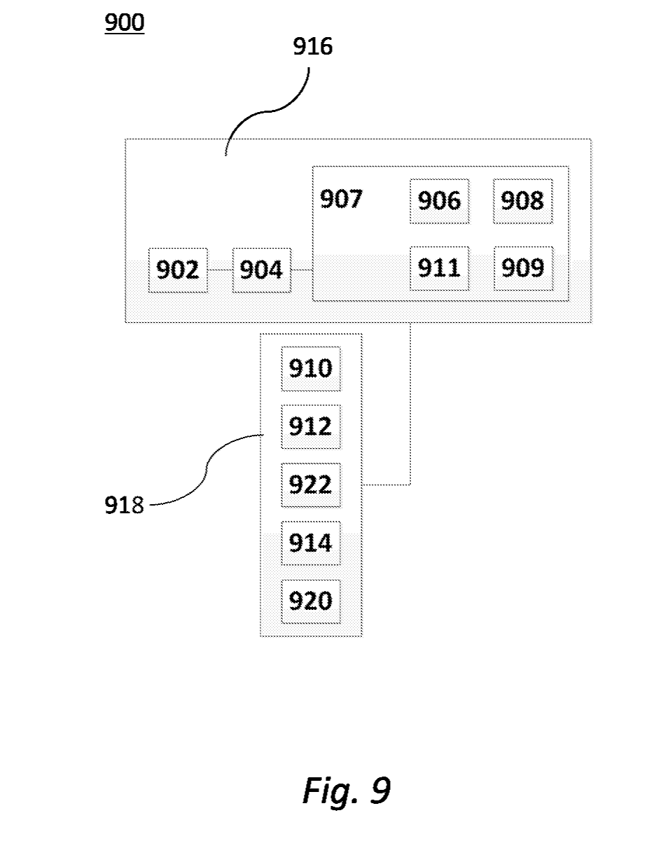

Referring now to FIG. 9, the payment processing and consumption tracking connectivity are illustrated. The payment processing infrastructure 916 is summarized by the set of systems including the Point of Sale System 902, The Payment Terminal or Payment Gateway 904, and the Payment Network 907. The consumption-tracking infrastructure 918 includes one or more of the Host System 910, a User Device 912, An Intermediate Processor or System 922, a Collector 914, and a second User Device 920 or combinations thereof. In accordance with the present invention, an exemplary embodiment includes connectivity between the payment processing infrastructure 916 and the consumption-tracking infrastructure 918. Embodiments of such connectivity enable product information to be upgraded by computation operations and determination of the adherence metric. For example, computation operations can lead to calculating the product content dimensions for a set of purchases by a given member.

In one embodiment, member information, product information, and purchase ticket information are transmitted among the Point of Sale System 902, the Payment Network 907, and the User Device 912. The Point of Sale System 902 and the Card-Issuing Bank 909 are in communication with one another, the Point of Sale System 902 and User Device 912 are in communication with one another, and the User Device 912 and the Card-Issuing Bank 909 are in communication with one another. One feature of the invention is the connectivity between User Device 912 and the Card-Issuing Bank 909, simultaneously with the connectivity between User Device 912 and the Point of Sale System 902. In one embodiment, such connectivity involves Intermediate Processors or Systems 922. In one embodiment, Intermediate Processors or Systems 922 can be associated with systems of financial services entities. Financial services entities include but are not limited to any of VISA, Mastercard, American Express and combinations thereof. Therefore, data transmissions occur across one or more communications networks, potentially involving one or more Intermediate Processors or Systems 922. Data transmissions typically involve modification of information. For example, the transmissions from the Point of Sale System 902 to the User Device 912 involve the upgrading of information for the member by means of computational operations at an Intermediate Processor or System 922 and/or at the User Device 912. A member initiates the transaction by scanning or otherwise entering products and payment information at the Point of Sale System 902, which is connected to a payment card reader such as that within a payment terminal. Payment authorization or settlement processes are conducted in cooperation with the member's Card-Issuing Bank 909 within the Payment Network 907. In one embodiment, the Front-End Processor 906 and the Bank-End Processor 908 are in communication with the Card-Issuing Bank 909 and the Merchant Bank 911 to conduct authorization or settlement processes. In one embodiment, the Card-Issuing Bank 909 provides the member's financial transaction history to User Device 912 so that the adherence metric can be determined at User Device 912 or at an Intermediate Processor or System 922. Computational operations that upgrade or otherwise modify raw data occur at an Intermediate Processor or System 922 or at User Device 912. The payment card includes but is not limited to a credit card, debit card, smart card, loyalty card, gift card, or other type of card that permits access to or storage of data. Transactions can be made at either a merchant's physical store or as internet transactions. The transmission of user financial history from Card-Issuing Bank 909 to User Device 912 in support of determining the adherence metric, may also be achieved manually by the member entering financial transaction data. This system connectivity enables product information to be upgraded by calculating cumulative product content dimension consumption data and determining an adherence metric in accordance with the present invention.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s) and steps or elements from methods in accordance with the present invention can be executed or performed in any suitable order. Therefore, it will be understood that the appended claims are intended to cover all such modifications and embodiments, which would come within the spirit and scope of the present invention.

What is claimed is:

1. A method for determining consumption data comprising the steps of:
acquiring member information, product information and purchase ticket information for a given purchase by a given member, the member comprising an individual, a household, a group, a third party, or combinations thereof, the member information comprising member identification, payment information, credentials, pass codes, account numbers or combinations thereof, the product information comprising product content dimensions, product identifiers, colors, volumes, weights, health indications, packaging information, manufacturers, sources or combinations thereof, the purchase ticket information comprising purchase date, purchase time, merchant information or combinations thereof;
associating one or more of a plurality of product content dimensions with one or more of a plurality of products for at least two purchases by a given member, the product content dimensions comprising quantitative or qualitative values of any of nutrients, calories, ingredients, chemicals, and combinations thereof, the nutrients comprising any of carbohydrates, fats, proteins, minerals, vitamins and combinations thereof;
summing one or more of a plurality of product content dimensions associated one or more of plurality of products for a given purchase by a given member;
summing cumulatively one or more of a plurality of product content dimensions from a given purchase with the equivalent product content dimensions from at least one past purchase by a given member;
generating a cumulative set of data points for a given product content dimension over a period of time or set of purchases by a given member;
using the cumulative set of data points to identify consumption data, the consumption data comprising rates, ratios or combinations thereof for one or more of a plurality of product content dimensions over a given period of time or a set of purchases by a given member;
using the cumulative set of data points over a period of time or set of purchases to identify one or more of a plurality of trends, the trends comprising one or more of a plurality of equations, lines or curves;
determining one or more of a plurality of slopes associated with the one or more of the plurality of equations, lines or curves; and
using the slopes to determine consumption rates for a given member, consumption rates comprising consumption over a period of time or a set of purchases.

2. The method of claim 1, wherein any of the member information, product information, purchase ticket information, or combinations thereof is acquired from at least one of a point of sale, a host system, a payment network, a user device, a member, a third party, or combinations thereof, the host system, the payment network or the user device configured to execute one or more of a plurality of algorithms.

3. The method of claim 2, wherein any of the host system, the payment network or the user device are in communication with the point of sale system.

4. The method of claim 1, wherein any of the member information, product information, purchase ticket information, or combinations thereof are received by at least one of a host system, a payment network, a user device, a member, a third party or combinations thereof, the host system, the payment network or the user device configured to execute one or more of a plurality of algorithms.

5. The method of claim 1, wherein the product dimensions are retrieved from a database, the database associating product identifiers with product dimensions, the product identifiers comprising barcodes, SKUs, UPCs, names, images or combinations thereof.

6. The method of claim 1, wherein the method further comprises:
using the consumption data to present textual and graphical representations of historical, current, or predictive consumption data to a given member, member account, user device, third party, output device, or combinations thereof.

7. The method of claim 6, wherein the consumption data comprises nutrition consumption rates based on one or more of a plurality of purchases by a given member, the nutrition consumption rates comprising consumption rates of calories, fat, protein, carbohydrates, minerals, vitamins, or combinations thereof.

8. The method of claim 1, wherein the method further comprises:
using the consumption data to identify and communicate suggestions, advertisements, and recommendations or combinations thereof to a member, member account, third party, output device or user device.

9. The method of claim 1, wherein the method further comprises:
using the slopes to generate one or more of a plurality of moving averages for the slopes over a period of time; and
using the one or more of a plurality of moving averages to smooth product content consumption rates over a period of time or set of purchases by a given member.

10. A method for determining consumption data comprising the steps of:
acquiring member information, product information and purchase ticket information for a given purchase by a given member, the member comprising an individual, a household, a group, a third party, or combinations thereof, the member information comprising member identification, payment information, credentials, pass codes, account numbers or combinations thereof, the product information comprising product content dimensions, product identifiers, colors, volumes, weights, health indications, packaging information, manufacturers, sources or combinations thereof, the purchase ticket information comprising purchase date, purchase time, merchant information or combinations thereof;
associating one or more of a plurality of product content dimensions with one or more of a plurality of products for at least two purchases by a given member, the product content dimensions comprising quantitative or qualitative values of any of nutrients, calories, ingredients, chemicals, and combinations thereof, the nutrients comprising any of carbohydrates, fats, proteins, minerals, vitamins and combinations thereof;
summing one or more of a plurality of product content dimensions associated one or more of plurality of products for a given purchase by a given member;
summing cumulatively one or more of a plurality of product content dimensions from a given purchase with the equivalent product content dimensions from at least one past purchase by a given member;
generating a cumulative set of data points for a given product content dimension over a period of time or set of purchases by a given member;
using the cumulative set of data points to identify consumption data, the consumption data comprising rates, ratios or combinations thereof for one or more of a plurality of product content dimensions over a given period of time or a set of purchases by a given member;
using the cumulative set of data points over a period of time or set of purchases to identify one or more of a plurality of trends, the trends comprising one or more of a plurality of equations, lines or curves;
determining one or more of a plurality of slopes associated with the one or more of the plurality of equations, lines or curves;
using the slopes to determine consumption rates for a given member, consumption rates comprising consumption over a period of time or a set of purchases;
acquiring financial transaction data for the user, the financial transaction data comprising amounts of financial transactions and product-type categories over a period of time; and
calculating an adherence metric, the adherence metric comprising the ratio of recorded spending from tracking-enabled merchants divided by total captured spending in one or more of a plurality of product-type categories, the adherence metric giving an estimated percentage of adherence to tracking-enabled merchants.

11. The method of claim 10, wherein the adherence metric is used to update a member account, third party, user device or output device with adherence-adjusted consumption data.

12. The method of claim 10, wherein the financial transaction data for a given member is acquired from at least one of a payment network, one or more of a plurality of banks, a member, a user device, a third party, or combinations thereof.

13. The method of claim 10, wherein the adherence metric provides an estimate of consumption for a given product content dimension, the estimate determined by dividing the tracked product content consumption by the adherence metric or one or more of a plurality of functions of the adherence metric.

14. The method of claim 10, wherein the method further comprises:
using the adherence-adjusted consumption data to present textual and graphical representations of historical, current, or predictive consumption data to a given member, member account, third party, user device, or output device.

15. The method of claim 10, wherein the method further comprises:
using the adherence metric to present quantitative or qualitative comparisons of consumption data for one or more of a plurality of members, the adherence metric comprising the same or different values, the one or more of a plurality of members comprising the same or different sizes.

16. The method of claim 10, wherein the method further comprises:
using the adherence-adjusted consumption rate to identify and communicate advertisements, suggestions, recommendations or combinations thereof to a member, third party, member account, user device, or output device.

17. The method of claim 10, wherein the method further comprises:
using one or more of a plurality of product content dimensions from a given purchase by a given member for gaming, trivia, or direct communication with the member.

18. A method for determining consumption data and for gaming comprising the steps of:
acquiring member information, product information and purchase ticket information for a given purchase by a given member, the member comprising an individual, a household, a group, a third party, or combinations thereof, the member information comprising member identification, payment information, credentials, pass codes, account numbers or combinations thereof, the product information comprising product content dimensions, product identifiers, colors, volumes, weights, health indications, packaging information, manufacturers, sources or combinations thereof, the purchase ticket information comprising purchase date, purchase time, merchant information or combinations thereof;
associating one or more of a plurality of product content dimensions with one or more of a plurality of products for at least two purchases by a given member, the product content dimensions comprising quantitative or qualitative values of any of nutrients, calories, ingredients, chemicals, and combinations thereof, the nutrients comprising any of carbohydrates, fats, proteins, minerals, vitamins and combinations thereof;
summing one or more of a plurality of product content dimensions associated one or more of plurality of products for a given purchase by a given member;
summing cumulatively one or more of a plurality of product content dimensions from a given purchase with the equivalent product content dimensions from at least one past purchase by a given member;
generating a cumulative set of data points for a given product content dimension over a period of time or set of purchases by a given member;
using the cumulative set of data points to identify consumption data, the consumption data comprising rates, ratios or combinations thereof for one or more of a plurality of product content dimensions over a given period of time or a set of purchases by a given member;
using the cumulative set of data points over a period of time or set of purchases to identify one or more of a plurality of trends, the trends comprising one or more of a plurality of equations, lines or curves;
determining one or more of a plurality of slopes associated with the one or more of the plurality of equations, lines or curves;
using the slopes to determine consumption rates for a given member, consumption rates comprising consumption over a period of time or a set of purchases;
acquiring financial transaction data for the user, the financial transaction data comprising amounts of financial transactions and product-type categories over a period of time;
calculating an adherence metric, the adherence metric comprising the ratio of recorded spending from tracking-enabled merchants divided by total captured spending in one or more of a plurality of product-type categories, the adherence metric giving an estimated percentage of adherence to tracking-enabled merchants;
attributing a figure of merit to one or more of a plurality of product information, member information, or purchase information from one or more of a plurality of purchases by a given member;
using the figures of merit and a set of game rules to derive or adjust a member score;
communicating the member score to any of a member, member account, third party, user device, output device, and combinations thereof; and
using the member score to identify and communicate advertisements, suggestions, recommendations or combinations thereof to any of a member, member account, third party, user device, output device, and combinations thereof.

19. The method of claim 18, wherein one or more of a plurality of figures of merit are retrieved from a database, the database associating any of member information, product information, purchase information, and combinations thereof with a given figure of merit.

20. The method of claim 18, wherein one or more of a plurality of figures of merit are associated with at least one product content dimension for a given product or purchase by a member.

21. A system for processing member information, product information and purchase information comprising:
at least one point of sale system, the point of sale system configured to transmit member information, product information, and purchase information to a host system, the host system comprising:
at least one server machine comprising:
a communications system for receiving data from and transmitting data to one or more of a plurality of networks, systems or devices;
a queuing system and a parsing system configured to organize data;
a data storage system;
at least one internal processor and internal memory configured to perform computational operations; and
software configured to execute algorithms.

22. The system of claim 21, wherein the point of sale system comprises a retail device, a retail website, a payment terminal, a payment gateway, an entry device, or combinations thereof.

23. The system of claim 21, wherein transmissions between the point of sale system and the host system occur in whole or in part through a payment network, the payment network comprising processes and systems, the processes comprising authentication, authorization and settlement, the systems comprising hardware units, the hardware units configured to execute software.

24. The system of claim 21, wherein the one or more of a plurality of devices comprises a user device, the user device configured to store, process, transmit or receive data.

25. The system of claim 21, wherein the point of sale system comprises a payment processor, the payment processor configured to acquire, transmit or store member financial transaction history.

26. The system of claim 25, wherein the host system is in communication with the payment processor, the payment processor residing within the payment network, the payment processor comprising one or more of a plurality of front end processors and one or more of a plurality of back end processors.

27. The system of claim 26, where in the host system is configured to execute one or more of a plurality of algorithms, the algorithms providing an adherence metric determining an estimate, the adherence metric providing a quantity to account for purchases from non-tracking enabled merchants.

28. The system of claim 21, wherein the host system comprises reference databases and algorithms to identify and communicate suggestions, advertisements, or recommendations to a user device or output device.

29. The system of claim 21, wherein the host system comprises a nutrition game host or is in communication with a nutrition game host, the nutrition game host system comprising reference databases and game rules algorithms to identify one or more of a plurality of figures of merit, adjust member scores, identify and communicate suggestions, advertisements, or recommendations based on member scores.

30. The system of claim 29, wherein the host system is configured to conduct nutritional or product content dimension based games, the games using any of the product information, member information, purchase information, and combinations thereof acquired from a given point of sale transaction.
